(19) United States
(12) Patent Application Publication
(10) Pub. No.: US 2007/0057987 A1
(43) Pub. Date: Mar. 15, 2007

(54) Printing apparatus, print medium, printing method and program

(75) Inventors: Simichi Miyamoto, Kanagawa (JP); Takeshi Onishi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co. Ltd.

(21) Appl. No.: 11/333,549

(22) Filed: Jan. 18, 2006

(30) Foreign Application Priority Data
Sep. 14, 2005 (JP) P2005-267010

(51) Int. Cl. B41J 29/393

(52) U.S. Cl. 347/19

(57) ABSTRACT

A printing apparatus includes, a specifying unit that specifieds a position of a pringing region of a document image on a medium; an information generating unit that generates positional information indicating a respective part positions on the medium based on a size of the medium and the position of the printing region; an image generating unit that generates a code image, which is a print image including the positional information, at least within the printing region; and a printing unit that prints on the medium an image in which the document image and the code image are superposed.

### BACKGROUND OF THE INVENTION

1. Field of the Invention

The present invention relates to a printing apparatus, such as a copy machine or a printer, and to a print medium to be printed by such a printing apparatus.

2. Description of the Related Art

In recent years, a technology in which characters or pictures are drawn onto a special paper with fine dots printed thereon, and a user transfers data, such as the characters or the like written onto the paper, to a personal computer or a cellular phone such that the content is stored or transmitted by mail. In this technology, small dots are printed on the special paper by intervals, for example, of about 0.3 mm, and different patterns are drawn for every grid having a predetermined size. These are read by use of a dedicated pen with a digital camera incorporated therein, and thus positions of the characters or the like written onto the special paper can be specified. Therefore, such characters or the like can be used as electronic information.

Here, as the related art publication, a method has been known in which a regular form is printed on such a special paper, and an item within the regular form is assigned, such that detailed information on the item can be referred to. Specifically, information for identifying the item on the paper is managed in association with the detailed information of the item, and the detailed information on the item read by a user with a reading device is transmitted to a user terminal.

As such, in order to associate electronic information with a medium, such as a paper or the like, a correspondence relationship between the electronic information and a position on the medium, on which an image on the electronic information is printed, needs to be managed, and the correspondence relationship at the time of printing needs to be cleared.

By the way, when an electronic document is printed on the medium, if printing parameters, such as a blank, a binding margin, and the like, are assigned, a position where the image is actually printed on the medium varies. Further, an application program (hereinafter, referred to as ‘application’), which instructs printing of the electronic document, may not recognize an influence of the printing parameters. In such a case, a printing position of the image on the medium which is recognized by a printing apparatus does not match with a printing position of the image recognized by the application, which instructs printing of the electronic document, at the time of printing. Accordingly, there is a problem in that a corresponding position in the electronic document cannot be accurately specified from a position on the medium read by a dedicated pen.

In the related art described above, this problem has not been considered. That is, in the related art, any effective unit for solving the problem that the printing position of the image recognized by the application does not match with the actual printing position on the medium is not provided.

### SUMMARY OF THE INVENTION

The present invention has been made in view of the above circumstances and provides a printing apparatus, print medium, printing method and program.

### BRIEF DESCRIPTION OF THE DRAWINGS

Embodiments of the present invention will be described in detail based on the following figures, wherein:

FIG. 1 is a diagram showing an overall configuration of a system to which an embodiment of the present invention is applied;

FIG. 2 is a block diagram showing a functional configuration of a system in an embodiment of the present invention;

FIG. 3 is a diagram showing an example of a printing parameter in an embodiment of the present invention;

FIGS. 4A and 4B are diagrams illustrating an outline of an operation when a binding margin is not assigned;

FIGS. 5A and 5B are diagrams illustrating an outline of a first operation in the embodiment when a binding margin is assigned;

FIGS. 6A to 6C are diagrams illustrating an outline of a second operation in the embodiment when a binding margin is assigned;

FIGS. 7A and 7B are diagrams illustrating an outline of a third operation in the embodiment when a binding margin is assigned;

FIG. 8 is a flowchart showing an operation of a parameter acquiring unit in an embodiment of the present invention;

FIGS. 9A to 9C are flowcharts showing an operation of a positional information generating unit in an embodiment of the present invention;

FIG. 10 is a block diagram showing a functional configuration of a code image generating unit in an embodiment of the present invention;

FIGS. 11A and 11B are diagrams illustrating code arrangement to be generated in an embodiment of the present invention;

FIGS. 12A to 12D are diagrams showing a bit pattern image to be used in an embodiment of the present invention;

FIG. 13 is a diagram showing an overall configuration of an image forming apparatus in an embodiment of the present invention;

FIG. 14 is a diagram showing an overall configuration of another system to which an embodiment of the present invention is applied.

### DETAILED DESCRIPTION OF PREFERRED EMBODIMENTS

Hereinafter, the best mode (hereinafter, referred to as ‘embodiment’) for carrying out the present invention will be described with reference to the accompanying drawings.

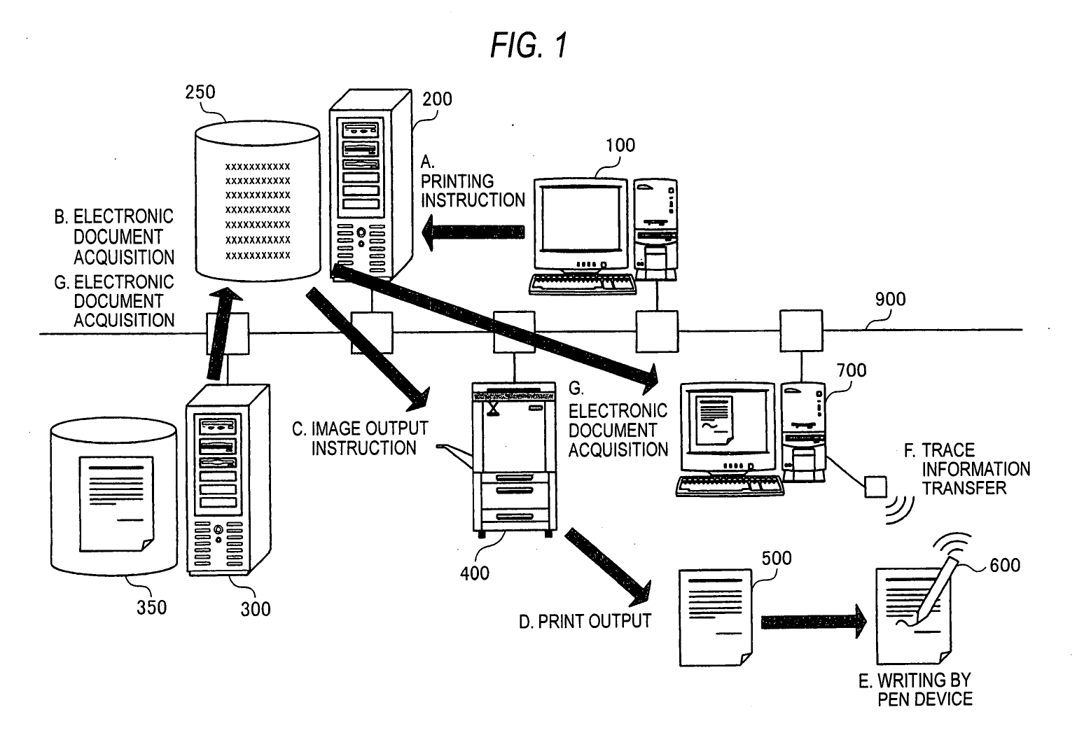

FIG. 1 is a diagram showing an example of the configuration of a system, to which the present embodiment is applied. This system has at least a terminal device 100 that instructs printing of an electronic document, an identification information management server 200 that manages identification information, which is imparted to a medium surface when the electronic document is printed, and generates an image including a code image indicating the identification information or the like, a document management server 300 that manages an electronic document, and an image forming apparatus 400 that prints the image generated by the identification information management server 200 on the medium surface, all of which are connected to a network 900.

Further, an identification information repository 250, which serves as a storage device for storing the identification information, is connected to the identification information management server 200, and a document repository 350, which serves as a storage device for storing an electronic document, is connected to the document management server 300.

In addition, this system includes a printed matter 500 that is outputted by the image forming apparatus 400, and a pen device 600 that records a character or graphic in the printed matter 500 and reads a trace of the character or graphic. Further, to the network 900, a terminal device 700 that displays the trace read by the pen device 600, if necessary, in association with the electronic document is connected.

Hereinafter, the outline of the operation of the present system will be described.

First, the terminal device 100 instructs the identification information management server 200 to superpose a code image on an image of an electronic document which is managed in the document repository 350 and to print the superposed image (A). At this time, printing parameters, such as a paper size, a paper direction, a blank, a binding margin, centering, and the like are inputted from the terminal device 100.

Accordingly, the identification information management server 200 acquires the electronic document, which is instructed to be printed, from the document management server 300 (B). Next, code images indicating identification information, which is managed in the identification information management server 250, and positional information determined according to the printing parameters are imparted to the image of the acquired electronic document, and then the image forming apparatus 400 is instructed to perform printing (C). Here, the identification information is information for uniquely identifying the electronic document or the medium (surface thereof), and the positional information is information for specifying coordinates (X and Y coordinates) on the medium surface.

As such, if the print instruction is received from the identification information management server 200, the image forming apparatus 400 outputs the printed matter 500 (D).

Moreover, the image forming apparatus 400 will be described below in detail. Here, it is assumed that the image forming apparatus 400 forms the code image imparted by the identification information management server 200 by use of an invisible toner having an absorption index of infrared light higher than a predetermined reference, and forms other images (images of portions included in the original electronic document) by use of a visible toner having an absorption index lower than the predetermined reference.

On the other hand, it is assumed that a user records (write) a character or graphic into the printed matter 500 by use of the pen device 600 (E). Accordingly, the pen device 600 acquires the identification information and the positional information from the printed matter 500 at intervals of constant time. Specifically, the information is read by an infrared light irradiation function and an infrared light detection function of the pen device 600.

Next, the pen device 600 transfers trace information of the character or graphic, which is determined on the basis of the positional information, and the identification information to the terminal device 700 in a wired or wireless manner (F).

Subsequently, the terminal device 700 transmits the identification information to the identification information management server 200 so as to request the transmission of the electronic document corresponding to the identification information. Upon receiving this request, the identification information management server 200 acquires the electronic document corresponding to the identification information from the document management server 300, and transmits the acquired electronic document to the terminal device 700 (G). As a result, on the terminal device 700, a synthesized image of the electronic document transmitted from the identification information management server 200 and a trace obtained from the pen device 600 is displayed.

In the above description, the system, to which the present embodiment is applied, has been described, but this configuration or operation is just an example. For example, one server may have a function of the identification information management server 200 and a function of the document management server 300. Further, the function of the identification information management server 200 may be implemented by an image processing unit (not shown) of the image forming apparatus 400. In addition, the terminal devices 100 and 700 may be the same terminal device.

Further, in the present specification, the term ‘electronic document’ is used, but this term does not mean only data obtained by making ‘a document’ including a text in an electronic form. For example, image data, such as a picture, a photograph, a graphic, or the like, (not on the basis of raster data or vector data) and other printable electronic data are included in ‘the electronic document’.

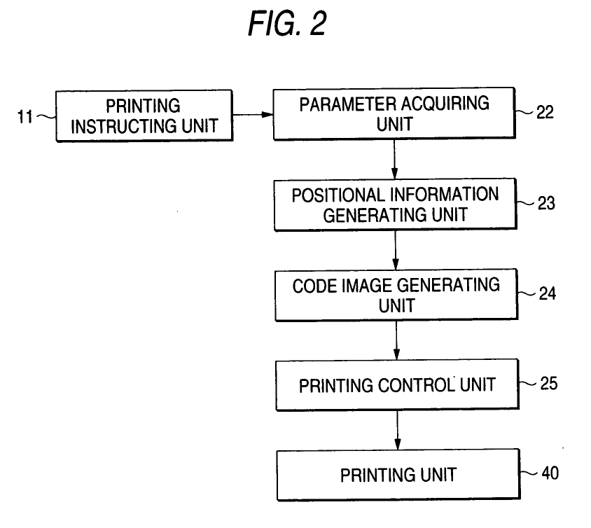

On the other hand, such a system configuration is conceptually shown, like FIG. 2.

That is, the present system includes a printing instructing unit 11, a parameter acquiring unit 22, a positional information generating unit 23, a code image generating unit 24, a printing control unit 25, and a printing unit 40.

Among these, the printing instructing unit 11 sends the electronic document and the printing parameters to the parameter acquiring unit 22, and instructs printing. In FIG. 1, the printing instructing unit 11 corresponds to the terminal device 100, but may be implemented other devices.

Further, the parameter acquiring unit 22 receives the print instruction from the printing instructing unit 11, and calculates a position of a region (hereinafter, referred to as ‘printing region’) where the image of the electronic document is printed. Next, information (hereinafter, referred to as ‘region information’) indicating the position of the printing region, the electronic document, and the printing parameters are sent to the positional information generating unit 23. Moreover, the parameter acquiring unit 22 analyzes the printing parameters and specifies the position of the printing region, and thus, from this point of view, the parameter acquiring unit 22 can be implemented as a specifying unit.

The positional information generating unit 23 generates the positional information on the basis of the region information received from the parameter acquiring unit 22 and information of a printer device. Next, the generated positional information, the electronic document, and the printing parameters are sent to the code image generating unit 24. Alternatively, the positional information generating unit 23 may generate the positional information on the basis of only the information of the printer device. Moreover, the positional information generating unit 23 generates the information, such as the positional information and the like, and thus, from this point of view, the positional information acquiring unit 23 can be implemented as an information generating unit.

When the positional information generating unit 23 generates the positional information on the basis of the region information and the information of the printer device, the code image generating unit 24 generates a code image, which, is actually printed, from the positional information. Next, the code image and the electronic document are sent to the printing control unit 25. Alternatively, when the positional information generating unit 23 generates the positional information on the basis of only the information of the printer device, the code image generating unit 24 generates the code image on the basis of the positional information and the region information acquired from the positional information generating unit 23. Moreover, the code image generating unit 24 generates images, such as the code image and the like, and thus, from this point of view, the code image generating unit 24 can be implemented as an image generating unit.

The printing control unit 25 analyzes the printing parameters, and superposes the received code image on the image of the electronic document so as to generate an image for printing. Next, the image for printing is sent to the printing unit 40.

Moreover, in FIG. 1, the parameter acquiring unit 22, the positional information generating unit 23, the code image generating unit 24, and the printing control unit 25 are implemented by the identification information management server 200 but may be implemented by other devices.

Further, these functions are implemented through the cooperation of hardware and software resources. That is, for each of the functions of the printing instructing unit 11, the parameter acquiring unit 22, the positional information generating unit 23, the code image generating unit 24, and the printing control unit 25, a CPU (not shown) of a device, which implements the corresponding function, reads a program, which implements the corresponding function, from an external storage device to a main storage device, and performs a processing.

On the other hand, the printing unit 40 is a printer, which performs printing on the medium on the basis of the received image, or the like, and corresponds to the image forming apparatus 400 in FIG. 1.

Here, the printing instructing unit 11 transmits the electronic document as the print instruction, and the electronic document is delivered to the printing control unit 25 and is made in an image by the printing control unit 25 to be superposed with the code image. However, the electronic document as the print instruction is not necessarily included. For example, a document image in an electronic form may obtained by reading an original paper document with a scanner and may be inputted to the print instruction, and, in the printing control unit 25, the document image may be superposed with the code image.

Next, the operation of the system of FIG. 2 will be described in more detail.

In the present system, the printing instructing unit 11 first instructs the parameter acquiring unit 22 to perform printing according to the printing parameters.

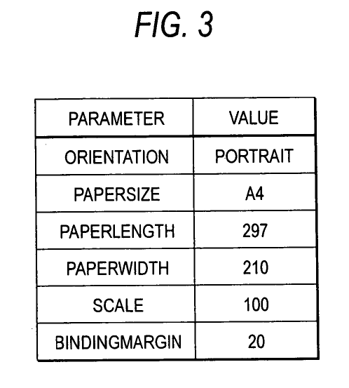

FIG. 3 is a diagram showing examples of the printing parameters. Hereinafter, the individual parameters of FIG. 3 will be described.

A parameter ‘ORIENTATION’ is provided to assign the paper direction. As the paper direction, ‘PORTRAIT’ indicating a direction in which a longitudinal direction is aligned with a vertical axis, and ‘LANDSCAPE’ indicating a direction in which a lateral direction is aligned with the vertical axis can be used. Here, the former is assigned.

A parameter ‘PAPERSIZE’ is provided to assign the paper size. For example, the size of ‘A0’ to ‘A5’ can be assigned.

A parameter ‘PAPERLENGTH’ is provided to assign a length of the paper in a vertical direction, and a parameter ‘PAPERWIDTH’ is provided to assign a length of the paper in a horizontal direction. A unit thereof is ‘mm’. Moreover, these parameters need to be assigned when a regular size is assigned for the above-described parameter ‘PAPERSIZE’. However, there may be a case in which the regular size is not assigned for the parameter ‘PAPERSIZE’, and the paper size is directly assigned by the lengths of the paper in the vertical and horizontal directions, these parameters are provided. n

A parameter ‘SCALE’ is provided to assign an enlargement or contraction magnification, the unit of which is ‘%’. Moreover, in the present embodiment, for simplification, it is assumed that this parameter is constantly set to ‘100’, and enlargement and contraction is not considered.

A parameter ‘BINDING MARGIN’ is provided to assign a width of a binding margin, the unit of which is ‘mm’.

Moreover, the parameters shown in FIG. 3 are just examples. Various printing parameters which are normally considered may be sent from the printing instructing unit 11 to the parameter acquiring unit 22.

Among the printing parameters described above, for example, due to ‘BINDINGMARGIN’ for assigning the width 6f the binding margin, displacement between a printing position of an image to be recognized by an application and an actual printing position on the medium may occur.

In this case, in the present embodiment, a positional information generation processing or a code image generating processing is changed such that these printing positions are aligned with each other.

First, the outline on the generation of the code image in the present embodiment will be described.

In the present embodiment, when the binding margin is assigned as the printing parameter, the code image, which absorbs the positional displacement (offset) of the document image, is generated. For ease of understanding, first, a case in which the binding margin is not assigned will be described.

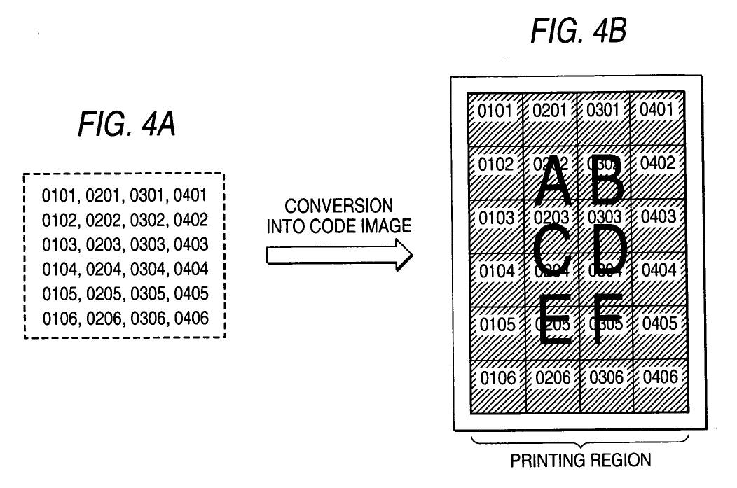

FIGS. 4A and 4B are diagrams showing the generation of the code image when the binding margin is not assigned and an offset does not occur.

Of them, FIG. 4A shows positional information within a region (printing region) where the document image is printed.

In the present embodiment, as described below, since a cell of about 3 mm×3 mm includes one positional information, an A4 paper includes positional information of about 70×99, but, here, for simple explanation, it is assumed that a paper includes positional information of 4×6. Further, individual positional information is represented by a 4-digit numerical value. Among the four digits, initial two digits represent a coordinate in the horizontal direction, and remaining two digits represent a coordinate in the vertical direction.

The positional information can be converted into the code image, as shown in FIG. 4B.

In FIG. 4B, the document image is represented by the characters ‘ABCDEF’, and the code image is represented by oblique lines. That is, when the binding margin is not assigned, the positional information is allocated to the entire surface of the printing region, such that the code image is generated. Moreover, in FIG. 4B, a numeric, which is not actually printed, in each of the cells of the code image indicates positional information corresponding to each cell.

Next, the generation of the code image when the binding margin is assigned will be described.

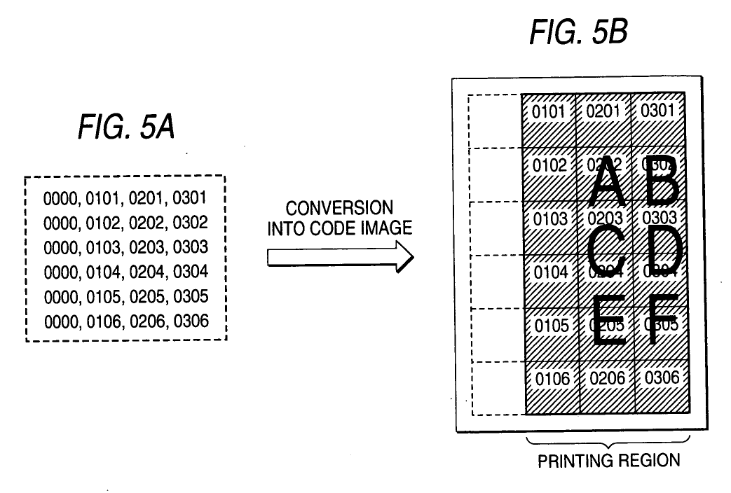

FIGS. 5A and 5B are diagrams showing a first method of absorbing the offset by adjusting the positional information when the binding margin is assigned.

In this example, it is assumed that the binding margin having the width corresponding to one cell is assigned, and the printing region is displaced to right by one cell. Next, as shown in FIG. 5A, in the positional information, the leftmost cell is allocated with a particular code (in FIG. 5A, ‘0000’), which indicates that the code image does not need to be generated at that position, and other cells are allocated with normal codes.

The positional information can be converted into the code image, as shown in FIG. 5B.

In FIG. 5B, the document image is represented by the characters ‘ABCDEF’, and the code image is represented by the oblique lines. That is, the code image is not printed on the leftmost cell, but printed only the region where the document image is printed. Moreover, in FIG. 5B, the numeric, which is not actually printed, in each of the cells of the code image represents positional information corresponding to each cell.

As such, in the example of FIGS. 5A and 5B, when the binding margin is assigned, ineffective positional information is allocated to a region corresponding to the binding margin, and thus the correspondence relationship between the document image and the code image is the same as the case of FIGS. 4A and 4B in which the binding margin is not assigned.

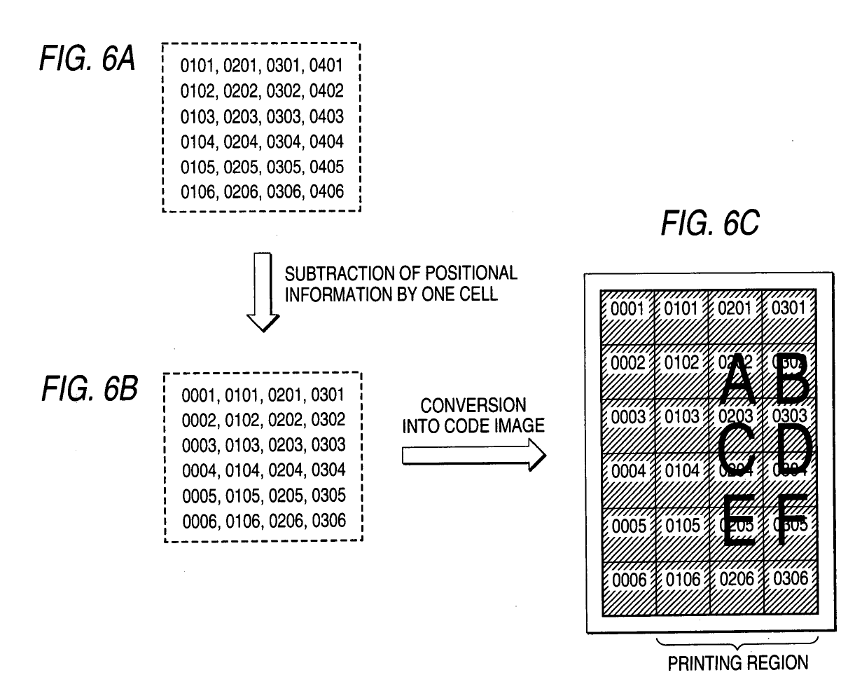

Further, FIGS. 6A to 6C are diagrams showing a second method of absorbing the offset by adjusting the positional information when the binding margin is assigned.

In this example, first, as shown in FIG. 6A, the positional information similar to the case in which the binding margin is not assigned is generated. Individual positional information is represented by a four-digit numerical value, and, among the four digits, initial two digits represent the coordinate in the horizontal direction, and remaining two digits represent the coordinate in the vertical direction. Further, in this example, it is assumed that the binding margin having a width corresponding to one cell is assigned, and the printing region is displaced to right by one cell. In addition, in FIG. 6B, for all positional information, the initial two digits representing the coordinate in the horizontal direction are made small by one cell.

The positional information can be converted into the code image, as shown in FIG. 6C.

In FIG. 6C, the document image is represented by the characters ‘ABCDEF’, and the code image is represented by the oblique lines. That is, the region where the code image is printed is not changed, but the positional information to be printed on each cell is made small by the amount assigned with the binding margin. Here, the binding margin is one cell, and thus individual positional information is made small by one cell. By doing so, the correspondence relationship between the document image and the code image is the same as the case of FIGS. 4A and 4B in which the binding margin is not assigned.

Moreover, according to this example, the code image is printed not only on the region where the document image is printed, but also on the region of the binding margin. Accordingly, the characters manually written up to the binding margin, as well as the characters manually written on the document image, can be held as the electronic information.

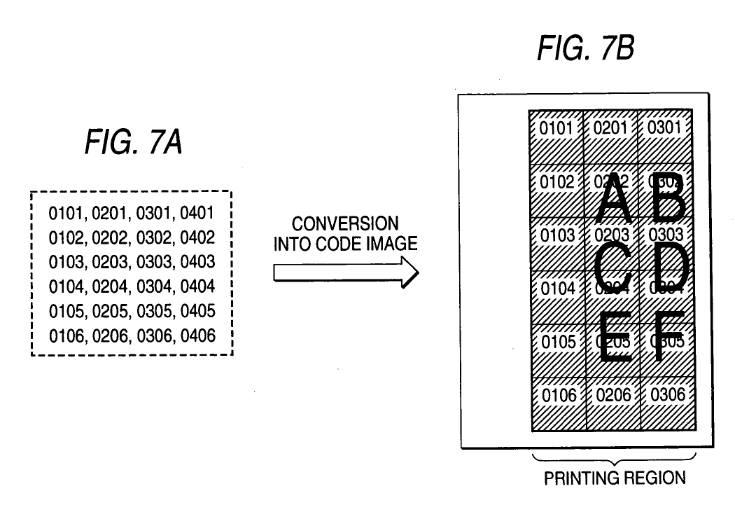

In addition, FIGS. 7A and 7B are diagrams showing a method of absorbing the offset by adjusting the generation position of the code image when the binding margin is assigned.

In this example, first, as shown in FIG. 7A, the positional information similar to the case in which the binding margin is not assigned is generated. Individual positional information is represented by a four-digit numerical value, and, among the four digits, initial two digits represent the coordinate in the horizontal direction and remaining two digits represent the coordinate in the vertical direction. Further, in this example, it is assumed that the binding margin having the width corresponding to one cell is assigned, and the printing region is displaced to right by one cell. In this case, the code image generating unit 24 refers to the printing parameters, and moves the generation position of the code image by the same amount as the assigned binding margin so as to generate the code image. With this processing, in FIG. 7B, the generation position of the code image is moved right by one cell. Accordingly, the code image is not printed on the binding margin, and the position on the document image and the position represented by the code image are aligned with each other.

Next, when printing is performed in the above-described manner with the configuration shown in FIG. 2, the detailed operation will be described. Moreover, in the description of this operation, a lateral direction of the paper is an X direction, and a longitudinal direction thereof is a Y direction.

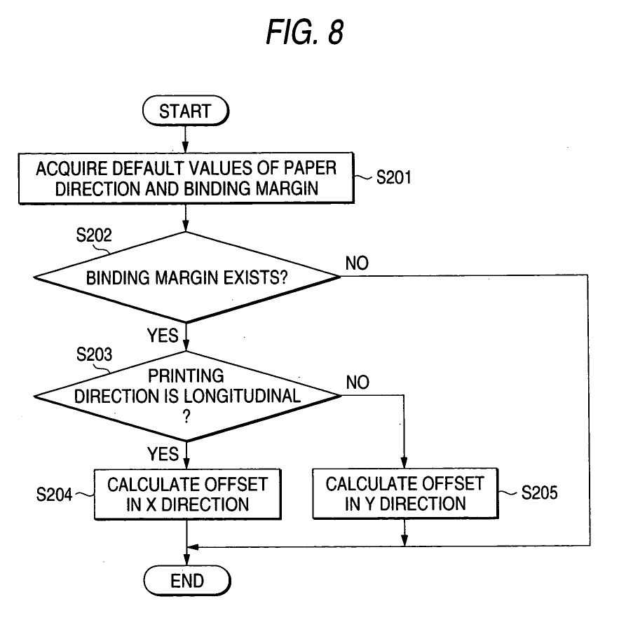

FIG. 8 is a flowchart showing the operation of the parameter acquiring unit 22.

First, the parameter acquiring unit 22 acquires default values of the paper direction and the binding margin (Step S201). Next, it is judged whether or not the binding margin is assigned (Step S202).

As a result, when the binding margin is not assigned, the processing ends as it is, whereas, when the binding margin is assigned, it is judged whether or not the paper direction is vertical (Step S203). Further, when the paper direction is vertical (PORTRAIT), the offset in the X direction is calculated (Step S204), whereas, when the paper direction is horizontal (LANDSCAPE), the offset in the Y direction is calculated (Step 5205).

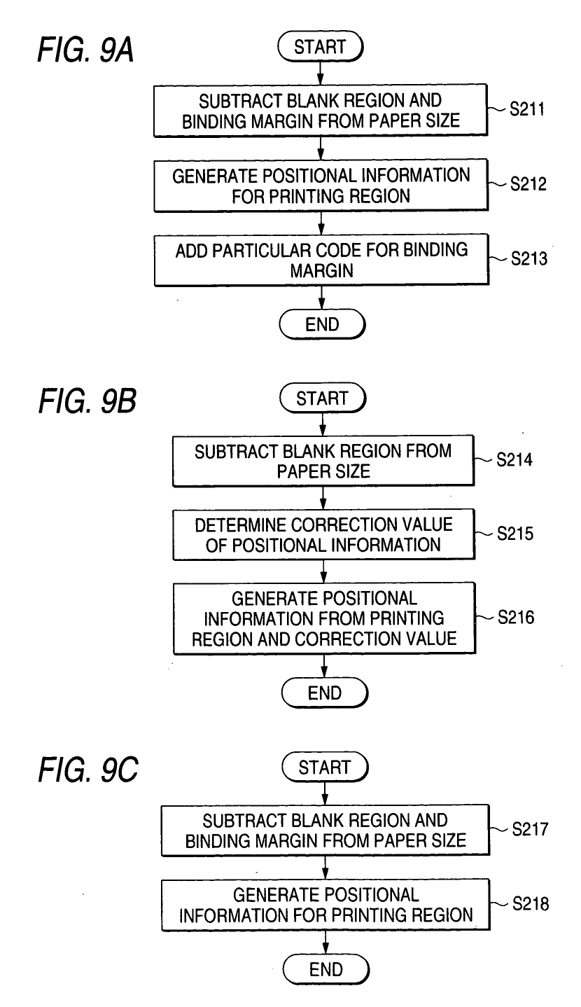

Further, FIGS. 9A to 9C are flowcharts showing the operation of the positional information generating unit 23.

Among these, FIG. 9A shows the operation of the positional information generating unit 23 in the example shown in FIGS. 5A and 5B.

In this case, the positional information generating unit 23 first determines the printing region by subtracting a blank region and the binding region from the paper size (Step S211).

Next, the positional information for the printing region is generated (Step S212).

Further, finally, a particular code for the binding margin is added (Step S213).

FIG. 9B shows the operation of the positional information generating unit 23 in the example shown in FIGS. 6A to 6C.

In this case, the positional information generating unit 23 first subtracts the blank region from the paper size and determines the region where the code image is printed (Step S214).

Next, a correction value of the positional information is determined on the basis of the position and area of the binding margin (Step S215).

Further, finally, the positional information is generated on the basis of the region where the code image is printed and the correction value (Step S216).

Moreover, in the above description on FIG. 6, the positional information on the region where the code image is printed is generated, and then the value according to the position and area of the binding margin is subtracted from the positional information. In such a method, the operation is possible, but, in view of efficiency when the amount of the positional information is increased, the method shown in FIG. 9B is preferable.

On the other hand, FIG. 9C shows the operation of the positional information generating unit 23 in the example shown in FIGS. 7A and 7B.

In this case, the positional information generating unit 23 first subtracts the blank region and the binding margin from the paper size so as to determine the printing region (Step S217).

Next, the positional information on the printing region is generated (Step S218).

Next, the code image generating unit 24 will be described in detail.

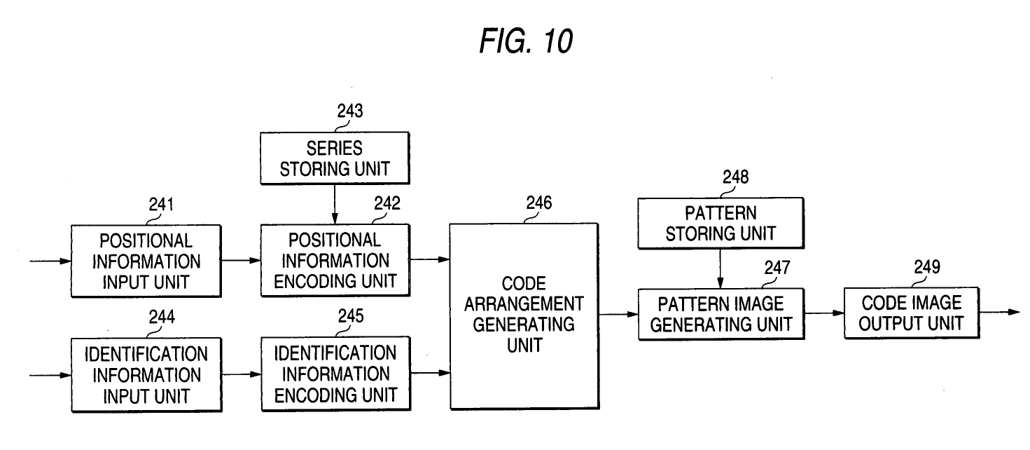

FIG. 10 is a block diagram showing the functional configuration of the code image generating unit 24.

As shown in FIG. 10, the code image generating unit 24 has a positional information input unit 241, a positional information encoding unit 242, a series storing unit 243, an identification information input unit 244, an identification information encoding unit 245, a code arrangement generating unit 246, a pattern image generating unit 247, a pattern storing unit 248, and a code image output unit 249.

Among these, the positional information input unit 241 acquires the positional information to be printed on the medium surface as the code image.

The positional information encoding unit 242 extracts a series having lengths in the X and Y directions corresponding to the acquired positional information (lengths to be subjected to position encoding) from the series storing unit 243, and generates encoded positional information (position code).

In the series storing unit 243, a pseudo noise series (M series) having a predetermined length is stored. Here, the M series is a series having the maximum cycle which can be generated by a k-stage linear shift register, and the cycle is 2^{k}−1. Further, from the nature, a consecutive k-bit partial series extracted from an arbitrary position in the M series appears in the M series only one time.

With this nature, the position of the consecutive k-bit partial series in the M series can be specified, and this can be applied to position detection. That is, if a coordinate value is associated in advance for each partial series, the conversion into the coordinate value can be performed by detecting the partial series.

For example, it is assumed that the M series (where k=11) having a series length 2047 is adopted, and each dot is printed at 600 dpi by use of a dot pattern image of 7 dots×7 dots. In this case, since one dot of 600 dpi is 0.0423 mm, 0.0423 mm×7×2047≅606 mm. Thus, the position on the medium surface up to the A2 size can be encoded.

Moreover, the M series stored in the series storing unit 243 may be determined in advance, or may be different for each printing apparatus. Further, it may be configured such that the series can be installed from the outside.

Further, if the number of positional information generated by the positional information generating unit 23 is P in the X direction and Q in the Y direction, it is assumed that the positional information encoding unit 242 extracts, from the series storing unit 243, an M series having the series length equal to or more than P×k bits as the M series for the X direction and an M series having the series length equal to or more than Q×k bits as the M series for the Y direction. However, in order to simplify the configuration of a decoding device, the M series for the X direction and the M series for the Y direction are preferably the same.

On the other hand, the identification information input unit 244 acquires identification information of the electronic document to be printed on the medium surface as the code image or identification information of the medium (surface thereof).

The identification information encoding unit 245 encodes the acquired identification information by a known error correction code, such as an RS code or the like, and generates encoded identification information (identification code). For example, it is assumed that identification information having a block bit length of 5 bits is encoded by the RS (16, 10) code. That is, it is assumed that a code length is 16 blocks, an information block length is 10 blocks, and error correctable blocks are 3 blocks. In this case, information of 50 bits (5 bits/block×10 blocks) can be embedded into the RS code. If the identification information can be represented by 50 bits, the electronic documents or mediums (surfaces thereof) of about 1126 trillion kinds can be identified.

The code arrangement generating unit 246 generates a two-dimensional code arrangement from the position code and the identification code. Moreover, a specified example of the code arrangement will be described below.

The pattern image generating unit 247 refers to the individual values of the code arrangement and arranges a corresponding bit pattern image.

In the pattern storing unit 248, the bit pattern image read out from the pattern image generating unit 247 is stored. Moreover, a specified example of the bit pattern image will be described below.

The code image output unit 249 outputs an image, in which the bit pattern image is arranged, as the code image. As described above, by using the M series (where k=11) and the RS code, the area corresponding to about 1126 trillion sheets of the A2 size can be encoded.

Here, the code arrangement to be generated by the code arrangement generating unit 246 will be described.

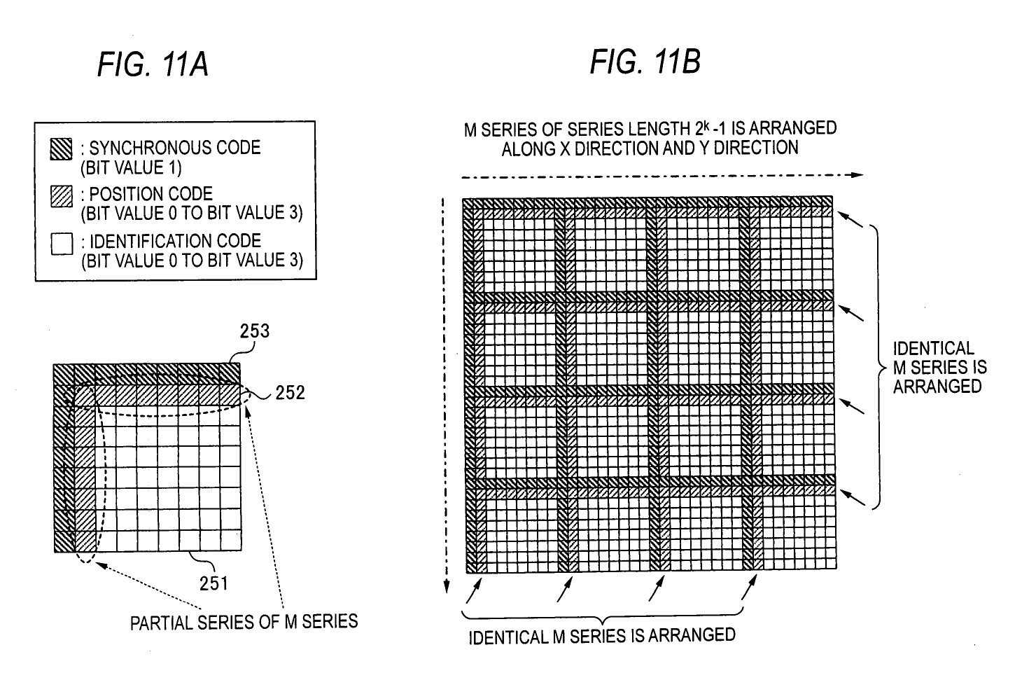

FIG. 11 shows an example of such a code arrangement.

In the code arrangement generating unit 246, the position code and the identification code are two-dimensionally arranged. The size of the two-dimensional arrangement may be made larger than the region to be printed when a code on the two-dimensional arrangement is substituted with a bit pattern image described below. That is, the code arrangement generating unit 246 may generate a two-dimensional arrangement of the paper size or may generate a two-dimensional arrangement of a size larger than the paper size.

In FIG. 11A, the identification code is arranged in an identification code portion. Further, a position code portion 252 on a circumference of the identification code portion 251, the position code encoded by the M series is arranged. In addition, a synchronous code for specifying an individual position code is arranged in a synchronous code portion 253 on a circumference of the position code portion 252. However, the synchronous code is not indispensable. For example, if the position of each code can be specified by a list of characteristic bits included in each code, the configuration which does not have the synchronous code is not provided can be considered.

Next, by two-dimensionally arranging the cells shown in FIG. 11A, a two-dimensional code arrangement shown in FIG. 11B is generated. Moreover, the same identification code is arranged for all cells surrounded by the synchronous codes, but the position code is different for each cell. That is, in the position code portion 252 of each cell, partial information corresponding to k bits extracted from the above-described M series is stored.

Next, the bit pattern image to be stored in the pattern storing unit 248 will be described.

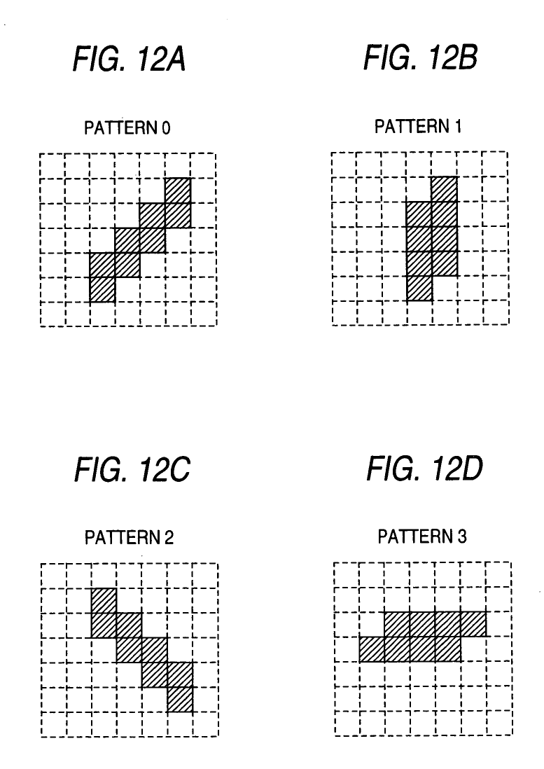

FIGS. 12A to 12D show examples of such a bit pattern image.

In FIGS. 12A to 12D, a minimum rectangular unit indicated by a dotted line represents one dot of the image (for example, 600 dpi). That is, the bit pattern image has 7 dots×7 dots as a unit. Since one dot of 600 dpi is 0.0423 mm, 7 dots×7 dots have the size of about 0.3 mm×0.3 mm. Further, resolution of the bit pattern image is about 86 dpi (=600 dpi+7 dots).

In the example of FIGS. 12A to 12D, the bit values 0 to 3 are represented by PATTERN 0 of FIG. 12A to PATTERN 3 of FIG. 12D. Therefore, information of 2 bits (four kinds) can be encoded by one bit pattern image. By making the code image by the bit pattern image, digital information can be embedded into the medium surface as the image.

Moreover, the shape of the bit pattern is not limited to those described above. That is, a method of encoding by ON (bit 1)/OFF (bit 0) of the dot or a method of encoding the bit value by the direction in which the dot is shifted from a virtual reference point, like JP-A-2004-102707, may be used.

Further, in the present embodiment, the bit pattern image is formed by an invisible toner having the maximum absorption index of 7% or less in a visible light region (400 nm to 700 nm) and having the absorption index of 30% or more in a near infrared region (800 nm to 1000 nm). Further, the invisible toner having an average dispersion diameter of 100 nm to 600 nm is adopted in order to increase a near infrared light absorption ability required for mechanical reading of the image.

Here, ‘visible’ and ‘invisible’ has no relation to whether or not to be recognizable by naked eyes. According to whether or not an image formed on a printed medium can be recognized by presence/absence of a color forming property caused by the absorption of a specified wavelength in the visible light region, ‘visible’ and ‘invisible’ are distinguished.

Next, the printing unit 40 will be described in detail.

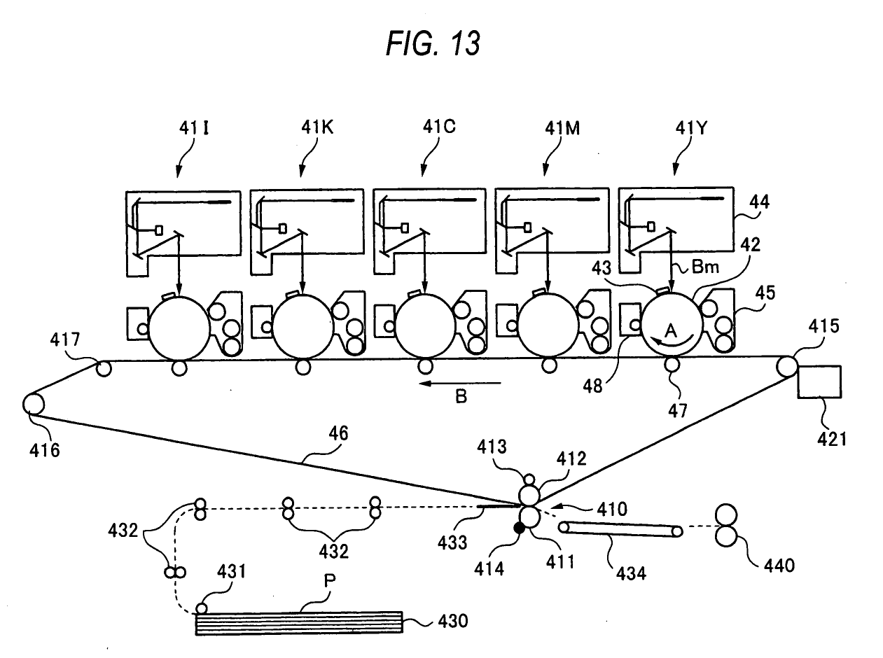

FIG. 13 is a diagram showing an example of the configuration of the printing unit 40. The printing unit 40 shown in FIG. 13 is a so-called tandem-type device, and has a plurality of image forming units 41 (41Y, 41M, 41C, 41K, and 41I) on which toner images of individual color components are formed in an electro-photographic method, an intermediate transfer belt 46 that sequentially transfers (primary transfer) and holds the toner images of the individual color components formed on the individual image forming units 41, a secondary transfer device 410 that collectively transfers (secondary transfer) a superposed image transferred on the intermediate transfer belt 46 to a paper (medium) P, and a fixing device 440 that fixes the secondarily transferred image on the paper P.

In the printing unit 40, in addition to the image forming units 41Y, 41M, and 41C that form the toner images of normal colors of yellow (Y), magenta (M), and cyan (C), the image forming unit 41K that forms a toner image of black (K) not having infrared absorption, and the image forming unit 41I that forms an invisible toner image are provided as one of the image forming units constituting the tandem.

Further, in the image forming unit 41I, a color material having infrared light absorption at the amount larger than a Y toner, an M toner, a C toner, and a K toner used in the image forming units 41Y, 41M, 41C, and 41K is used. For example, a color material containing vanadyl naphthalocyanine is exemplified. Moreover, as the K toner used in the image forming unit 41K, in order to facilitate the detection of the code image, a color material having infrared light absorption smaller than the color material used in the image forming unit 41I is preferably used, but, like a color material containing carbon, an infrared light absorbing color material, which is generally used, can be used.

In the present embodiment, each of the image forming units 41 (41Y, 41M, 41C, 41K, and 41I) has electrophotographic devices, which are sequentially provided, such as a charger 43 that is disposed in the vicinity of a photosensitive drum 42 rotating in a direction of an arrow A so as to charge the photosensitive drum 42, a laser exposure 44 that writes an electrostatic latent image on the photosensitive drum 42 (in FIG. 13, an exposure light beam is denoted by a symbol Bm), a developer 45, in which a corresponding color component toner is housed and which changes the electrostatic latent image on the photosensitive drum 42 into a visual image by the toner, a primary transfer roller 47 that transfers a corresponding color component toner image formed on the photosensitive drum 42 to the intermediate transfer belt 46, a drum cleaner 48 that removes a residual toner on the photosensitive drum 42, and the like. The image forming units 41 are arranged in an order of yellow (Y), magenta (M), cyan (C), black (K), and an invisible color (I) from an upstream side of the intermediate transfer belt 46.

Further, the intermediate transfer belt 46 is configured to be rotated in a direction of an arrow B shown in FIG. 13 by various kinds of rollers. As various kinds of rollers, a driving roller 415 that is driven by a motor (not shown) to rotate the intermediate transfer belt 46, a tension roller 416 that has a function of applying constant tension to the intermediate transfer belt 46 so as to prevent meandering of the intermediate transfer belt 46, an idle roller 417 that supports the intermediate transfer belt 46, and a backup roller 412 (described below) are used.

Further, it is configured such that a voltage having a polarity opposite to a charged polarity of the toner is applied to the primary transfer roller 47, and thus the toner image on the photosensitive drum 42 is sequentially absorbed in the intermediate transfer belt 46 in an electrostatic manner, such that a superposed toner image is formed on the intermediate transfer belt 46. In addition, the secondary transfer device 410 has a secondary transfer roller 411 that is pressed into contact with a toner image carrying surface of the intermediate transfer belt 46, and the backup roller 412 that is disposed on a rear side of the intermediate transfer belt 46 so as to serve as a counter electrode of the secondary transfer roller 411. A metal feeding roller 413, to which a secondary transfer bias is stably applied, comes into contact with the backup roller 412. Further, a brush roller 414 that removes blots. attached to the secondary transfer roller 411 is disposed to come into contact with the secondary transfer roller 411.

Further, on a downstream side of the secondary transfer roller 411, a belt cleaner 421 that clears the surface of the intermediate transfer belt 46 after the secondary transfer is provided.

In addition, in the present embodiment, as a paper feeding system, a paper tray 430 that houses the paper P, a pickup roller 431 that extracts and transports the paper P stacked in the paper tray 430 at a predetermined timing, a transport roller 432 that transports the paper P extracted by the pickup roller 431, a transport chute 433 that sends the paper transported by the transport roller 432 to a secondary transfer position by the secondary transfer device 410, a transport belt 434 that transports the paper P after the secondary transfer to the fixing device 440.

Next, an image creation process of the printing unit 40 will be described. If a start switch (not shown) is turned on by a user, a predetermined image creation process is executed. Specifically, for example, when the printing unit 40 is a color printer, digital image signals transmitted from the network 900 are temporarily stored in a memory, the toner images of individual colors are formed on the basis of the stored digital image signals of five colors (Y, M, C, K, and I).

That is, on the basis of image recording signals of the individual colors obtained by an image processing, the image forming units 41 (41Y, 41M, 41C, 41K, and 41I) are driven. Next, in the individual image forming units 41Y, 41M, 41C, 41K, 41I, with the laser exposure 44, the electrostatic latent image according to the corresponding image recording signal is written into the photosensitive drum 42 uniformly charged by the charger 43. Further, the written electrostatic latent image is developed by the developer 45, in which the toner of the corresponding color is housed, such that the toner image of the corresponding color is formed.

Next, the toner image formed on the photosensitive drum 42 is primarily transferred from the photosensitive drum 42 to the surface of the intermediate transfer belt 46 at a primary transfer position where the photosensitive drum 42 comes into contact with the intermediate transfer belt 46, by a primary transfer bias, which is applied by the primary transfer roller 47. The toner image, which is primarily transferred to the intermediate transfer belt 46 in such a manner, is superposed on the intermediate transfer belt 46, and is transported to the secondary transfer position along the rotation of the intermediate transfer belt 46.

On the other hand, the paper P is transported to the secondary transfer position of the secondary transfer device 410 at a predetermined timing, and the secondary transfer roller 411 nips the paper P to the intermediate transfer belt 46 (the backup roller 412). Next, with the action of a secondary transfer electric field to be formed between the secondary transfer roller 411 and the backup roller 412, the superposed toner image carried on the intermediate transfer roller 46 is secondarily transferred to the paper P.

Subsequently, the paper P, to which the toner image is transferred, is transported to the fixing device 440 by the transport belt 434, such that the toner image is fixed. On the other hand, after the secondary transfer, the residual toner of the intermediate transfer belt 46 is removed by the belt cleaner 421.

Next, another example of a system, to which the present embodiment is applied, will be described.

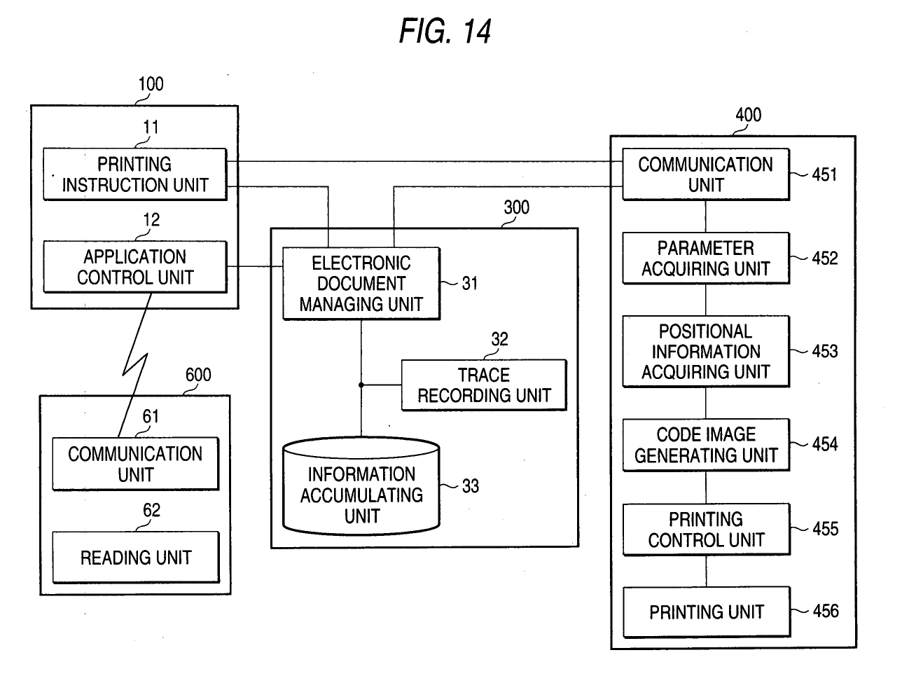

FIG. 14 shows the configuration of another system.

This system includes a terminal device 100, a document management server 300, an image forming apparatus 400, and a pen device 600. Further, in this system, the terminal device 100 serves as the terminal device 100 and the terminal device 700 of FIG. 1. Further, the document management server 300 has a function of managing the correspondence between the document image and the code information from the functions of the identification information management server 200 of FIG. 1. In addition, the image forming apparatus 400 has a function of generating the superposed image of the document image and the code image from the functions of the identification information management server 200 of FIG. 1, in addition to the functions of the image forming apparatus 400 of FIG. 1.

Hereinafter, the configuration of an individual device will be described in detail.

First, the terminal device 100 has a printing instructing unit 11, and an application control unit 12.

The printing instructing unit 11 instructs the image forming apparatus 400 to print the electronic document. At that time, the printing parameters, such as the blank, an N-up, the enlargement or contraction magnification, or the like, are assigned.

The application control unit 12 sends an event, which is the same as that when a mouse is clicked at a predetermined position where an existing application opens the document, to the application. For example, like sharing of the application of an electronic conference system, the application operates. At that time, the application control unit 12 calculates the position by use of the code information accumulated in an information accumulating unit 33. That is, if a specified position on the medium is tapped with the pen device 600, an event, which is the same as that when a position within a window of the application corresponding to the position on the medium is clicked with a left button of the mouse is sent to the application.

Further, the document management server 300 has an electronic document managing unit 31, a trace recording unit 32, and the information accumulating unit 33.

The electronic document managing unit 31 manages the printed electronic document in association with the code information allocated to the electronic document. Further, according to a request from the application control unit 12, the electronic document corresponding to the code information read from the medium and the positional information are repeatedly read from the information accumulating unit 33.

The trace recording unit 32 analyzes a movement trace of the pen device 600 on the basis of the positional information included in the code information so as to record movement information of the pen device 600. The movement information is displayed to be superposed with the electronic document corresponding to the medium, and is reproduced on the electronic document.

The information accumulating unit 33 is a storage device that accumulating the correspondence between the electronic document and the code information.

In addition, the image forming apparatus 400 has a communication unit 451, a parameter acquiring unit 452, a positional information generating unit 453, a code image generating unit 454, a printing control unit 455, and a printing unit 456.

The communication unit 451 receives the print instruction or the document image from the printing instructing unit 11. For example, a case in which communication is performed through the connection to an interface, such as a USB or the like, by a cable, or a case in which communication is performed through the connection by a wireless LAN, RS-232C, Bluetooth, or the like can be considered.

The parameter acquiring unit 452 analyzes the printing parameters delivered from the printing instructing unit 11, and extracts the parameters to be processed by the image forming apparatus 400. For example, the parameter that assigns the width of the binding margin corresponds thereto. The parameter acquiring unit 452 judges the printing region on the basis of the assignment of the binding margin and the assignment of the paper direction, and sends the parameters required for the positional information generating unit 453. For example, when vertical is assigned as the paper direction, A4 is assigned as the paper size, and 20 mm is assigned as the width of the binding margin, the value of 297 mm vertical and 190 mm horizontal is calculated as the printing region.

The positional information generating unit 453 generates the positional information from information of the printing parameters and the printing region received from the parameter acquiring unit 452. The number of generated positional information is determined by dividing the size of the printing region by the size of one cell of the code image to be generated by the code image generating unit 454. Moreover, the generated positional information represents a relative value, and a paper origin does not need to be aligned with an origin of the positional information.

For example, when the bit pattern images shown in FIGS. 12A to 12D are used, the paper direction is vertical, the paper size is A4, the width of the binding margin is 20 mm, and the value of 297 mm vertical and 190 mm horizontal is received as the size of the printing region, the positional information of 112 vertical and 72 horizontal are generated. As shown in FIG. 5, when particular positional information is allocated to the region of the binding region, in addition to the above-described positional information, the particular positional information of 112 vertical and 8 horizontal corresponding to 297 mm vertical and 20 mm horizontal are generated.

The code image generating unit 454 generates the code image corresponding to the positional information generated by the positional information generating unit 453.

The printing control unit 455 generates an image for printing from the electronic document, and superposes the code image at a predetermined position thereof.

The printing unit 456 prints the image sent from the printing control unit 455 on the medium.

In addition, the pen device 600 has a communication unit 61 and a reading unit 62.

The communication unit 61 transmits the read code information on the medium or the like. For example, a case in which communication is performed through the connection to an interface, such as a USB or the like, by a cable, or a case in which communication is performed by a wireless LAN, RS-232C, Bluetooth, or the like can be considered. In case of the system of FIG. 14, the pen device 600 communicates with the terminal device 100 through the communication unit 61.

The reading unit 62 reads the code image from the medium, and acquires the code information by analyzing the pattern of the code image.

Now, the description of the present embodiment ends.

As such, in the present embodiment, the positional information or the code image is adjusted, and thus printing can be performed such that the correspondence relationship between the printing position of the image recognized by the application and the actual printing position on the medium is not changed.

Further, when such the correspondence relationship of the printing positions is changed, a method can be considered in which a conversion table for storing the correspondence relationship between the position on the electronic document and the position on the medium is provided, and the position on the corresponding electronic document from the position on the medium read by a pen is calculated by referring to the conversion table. However, in this method, whenever the position on the electronic document is determined from the position on the medium, a conversion processing must be performed with reference to the conversion table, and an overhead is not negligible. In contrast, in the present invention, the positional information read from the medium can be used as the positional information in the electronic document as it is, and thus the association of the electronic document and the medium can be promoted with no overhead.

As described above, according to an aspect of the present invention, positional information is adjusted, and thus printing may be performed such that a correspondence relationship between a printing position of an image recognized by an application and an actual printing position on a medium is not changed. That is, according to the aspect of the present invention, there is provided a printing apparatus including: a specifying unit that specifies a position of a printing region of a document image on a medium; an information generating unit that generates positional information indicating a respective part positions on the medium based on a size of the medium and the position of the printing region; an image generating unit that generates a code image, which is a print image including the positional information, at least within the printing region; and a printing unit that prints on the medium an image in which the document image and the code image are superposed. According to another aspect of the present invention, a generation position of a code image is adjusted, and thus printing may be performed such that a correspondence relationship between a printing position of an image recognized by an application and an actual printing position on a medium is not changed. That is, according to the aspect of the present invention, there is provided a printing apparatus including: a specifying unit that specifies a position of a printing region of a document image on a medium; an information generating unit that generates positional information indicating a position on the medium on the basis of a size of the medium; an image generating unit that generates a code image, which is a print image including the positional information, on the basis of the position of the printing region; and a printing unit that prints on the medium an image in which the document image and the code image are superposed.

According to still another aspect of the present invention, there is provided a print medium including; a document image printed on the print medium with an offset being applied to a particular portion of the document image; a code image indicating a position of the particular portion of the document image. The code image is printed on the printing medium with being superposed on the document image.

According to still another aspect of the present invention, there is provided a printing method including; acquiring an offset value when a document image is printed on a medium; generating a code image corresponding to positional information indicating a position on the document image on the basis of the offset value; generating a synthesized image in which the document image and the code image are superposed; and printing the synthesized image on the medium.

According to further aspect of the present invention, there is provided a storage medium readable by a computer, the storage medium storing a program of instructions executable by the computer to perform a function. The function includes the steps of: acquiring an offset value when a document image is printed on a medium; generating a code image corresponding to positional information indicating a position on the document image on the basis of the offset value; and generating a synthesized image in which the document image and the code image are superposed.

According to the embodiment of the present invention, printing may be performed such that a correspondence relationship between a printing position of an image recognized by an application and an actual printing position on a medium is not changed.

The entire disclosure of Japanese Patent Application No. 2005-267010 filed on Sep. 14, 2005 including specification, claims, drawings and abstract is incorporated herein be reference in its entirety.

What is claimed is:

1. A printing apparatus comprising:
a specifying unit that specifies a position of a printing region of a document image on a medium;
an information generating unit that generates positional information indicating a respective part positions on the medium based on a size of the medium and the position of the printing region;
an image generating unit that generates a code image, which is a print image including the positional information, at least within the printing region; and
a printing unit that prints on the medium an image in which the document image and the code image are superposed.

2. The printing apparatus according to claim 1,
wherein the code image further includes identification information that identifies the medium or an electronic document as a source of the document image.

3. The printing apparatus according to claim 2,
wherein the image generating unit includes an encoding unit that encodes the positional information or the identification information.

4. The printing apparatus according to claim 1,
wherein the information generating unit generates the positional information by selecting from a positional information space having predetermined widths in two different directions, a subspace that has an area corresponding to a size of the medium.

5. The printing apparatus according to claim 4,
wherein the positional information space is obtained by encoding the positional information based on an M series in the two different directions individually.

6. The printing apparatus according to claim 4,
wherein the information generating unit generates the positional information by adding to the subspace, particular information that have an amount according to the position of the printing region.

7. The printing apparatus according to claim 4,
wherein the information generating unit generates the positional information by selecting the subspace from a area that is determined according to the position of the printing region in the positional information space.

8. A printing apparatus comprising:
a specifying unit that specifies a position of a printing region of a document image on a medium;
an information generating unit that generates positional information indicating a position on the medium on the basis of a size of the medium;
an image generating unit that generates a code image, which is a print image including the positional information, on the basis of the position of the printing region; and
a printing unit that prints on the medium an image in which the document image and the code image are superposed.

9. The printing apparatus according to claim 8,
wherein the code image further includes identification information that identifies the medium or an electronic document as a source of the document image.

10. The printing apparatus according to claim 9,
wherein the image generating unit includes an encoding unit that encodes the positional information or the identification information.

11. The printing apparatus according to claim 8,
wherein the information generating unit generates the positional information by selecting from a positional information space having predetermined widths in two different directions, a subspace that has an area corresponding to a size of the medium.

12. The printing apparatus according to claim 11,
wherein the positional information space is obtained by encoding the positional information based on an M series in the two different directions individually.

13. The printing apparatus according to claim 8,
wherein the image generating unit generates the code image within the printing region.

14. A print medium comprising;
a document image printed on the print medium with an offset being applied to a particular portion of the document image;
a code image indicating a position of the particular portion of the document image, the code image printed on the printing medium with being superposed on the document image.

15. A printing method comprising:
acquiring an offset value when a document image is printed on a medium;
generating a code image corresponding to image positional information indicating a position on the document image on the basis of the offset value;
generating a synthesized image in which the document image and the code image are superposed; and
printing the synthesized image on the medium.

16. The printing method according to claim 15,
wherein, in the generating of the code image, the image positional information is acquired by correcting medium positional information indicating a position on the medium according to the offset value.

17. The printing method according to claim 15,
wherein, in the generating of the code image, the code image is generated at a position that is determined according to the offset value.

18. A storage medium readable by a computer, the storage medium storing a program of instructions executable by the computer to perform a function, the function comprising the steps of:
acquiring an offset value when a document image is printed on a medium;
generating a code image corresponding to image positional information indicating a position on the document image on the basis of the offset value; and
generating a synthesized image in which the document image and the code image are superposed.

19. The storage medium according to claim 18,
wherein, in the generating of the code image, the image positional information is acquired by correcting positional information indicating a position on the medium according to the offset value.

20. The storage medium according to claim 18,
wherein, in the generating of the code image, the code image is generated at a position that is determined according to the offset value.
